(19) United States
(12) Patent Application Publication
(10) Pub. No.: US 2001/0027560 A1
(43) Pub. Date: Oct. 4, 2001

(54) Cable/satellite/internet-ready multimedia television

(76) Inventor: Rudy J. Simon, Dexter, ME (US)

Correspondence Address: THOMAS L. BOHAN & ASSOCIATES, 371 FORE STREET, SUITE 202, PORTLAND, ME, 04101, US

(21) Appl. No.: 09/845,000

(22) Filed: Apr. 28, 2001

Related U.S. Application Data
(63) Continuation-in-part of application No. 09/755,500, filed on Jan. 5, 2001.
Application No. 09/755,500 is a continuation-in-part of application No. 09/401,579, filed on Sep. 22, 1999, now Pat. No. 6,172,702.

(51) Int. Cl. H04N 7/16

(52) U.S. Cl. 725/1

(57) ABSTRACT

Cable/satellite/Internet-ready television providing surround-sound, purchase-payment, and multimedia capabilities. A satellite access card slot, a wireless communication system for transmitting signals to and from a remote control device, and a surround-sound control panel are integrated into the television cabinet. A credit/debit card reader is incorporated within the cabinet or remote control device.

This is a continuation-in-part of co-pending, commonly owned U.S. application Ser. No. 09/755,500 filed 01/05/2001, now abandoned, which is a continuation-in-part of U.S. application Ser. No. 09/401,579, filed 09/22/1999, U.S. Pat. No. 6,172,702.

### BACKGROUND OF THE INVENTION

1. Field of the Invention

This invention relates to a television. More particularly, the present invention relates to a television equipped with a tuner capable of receiving television signals that are of three general classes: radio-frequency (RF) broadcast signals, signals transmitted by cable, and signals transmitted by satellite. Yet more particularly, this invention relates to such a television that is capable of being operated through the use of a single set of controls, such as on a single remote control device, and is further capable of providing surround sound, reading credit card information, and has multimedia facilities.

2. Description of Related Art

At one time, television signals were radio-frequency (RF) signals broadcast through the air either as very high frequency (VHF) signals, or as ultra high frequency (UHF) signals. Initially, only twelve VHF channels were broadcast. Within a few years, numerous channels of UHF television signals were being broadcast in addition to the VHF channels. Today, there are hundreds of channels of RF television signals being broadcast over various media, including the airwaves, cable systems, satellite systems, and now the World Wide Web by means of the Internet.

Originally, televisions were equipped with a tuner and a dial that could handle the twelve VHF channels. A second dial was added to enable the viewer to select a VHF or UHF channel. Nowadays, televisions may have several external tuner boxes, generally stacked on top of one another on the top of the sets: one or more to receive the numerous RF channels, one or more to receive the many cable channels, and one for the satellite channels. These external tuner boxes along with the requisite cables to connect them to the television are prone to disarray. Each such external tuner box requires its own set of controls and each external tuner box interfaces with the channel-selection circuitry within the television itself. Given this situation, it is desirable to have a television capable of receiving broadcast RF signals, signals transmitted by cable (including optical cable), Internet signals (e.g., Web-TV), and signals transmitted by satellite. It is further desirable to have such a television that is controlled through the use of a single set of controls on the television itself so that external tuner boxes and connecting cables can be eliminated.

Cable television and the World Wide Web have presented viewers with the opportunity to purchase desired television programs (e.g., “Pay-per-View”), as well as advertised goods. At present, a viewer who desires to make such a purchase typically places a telephone call to an advertised telephone number, and then reads his or her credit card number to the person on the other end. Similarly, a call may be made to the customer's cable company to purchase movies, sports telecasts, and other pay-per-view programming. This process, needlessly cumbersome from the perspective of the viewer, is nevertheless the only option presently available to viewers.

There have been prior-art attempts to resolve some of the above-described deficiencies. For example, DeVilbiss (U.S. Pat. No. 4,737,993; issued 1988) discloses a tuning device capable of switching between broadcast and cable television transmissions, and simultaneously accommodating the different channels associated with the two broadcast modes. The DeVilbiss device, however, does not meet today's needs in that it is not capable of receiving and handling satellite television transmissions.

A television tuner that is capable of receiving broadcast and cable television transmissions and that is fully integrated on a single, physically small microcircuit capable of being produced inexpensively is taught by Rotzoll (U.S. Pat. No. 5,737,035; issued 1998). As with the DeVilbiss device, the Rotzoll device is also incapable of handling satellite television transmissions.

Another reference, Chimoto et al. (U.S. Pat. No. 5,838, 383; issued 1998), discloses a multimedia television receiver capable of receiving multimedia signals that are associated with a television signal in a wide variety of transmission and digital formats. The Chimoto et al. device does not include a unitary television console, nor does it include multimedia facilities that can operate independently of a television signal having embedded multimedia signals.

Ozaki (U.S. Pat. No. No. 5,601,581; 1997) teaches a satellite receiver that is equipped with a credit card reader. Because the Ozaki device is essentially a stand-alone receiver box and separate from the television with which it is used, the problems associated with the above-mentioned receivers are still present, including in particular, the cumbersome nature of multiple connection cables.

Some televisions come equipped with surround-sound. The surround-sound capability uses the four sound channels of the known superior video (S-video) input. Typically, televisions with surround-sound have speakers placed in the room where the television is, external to the television cabinet, and connected by cables to the S-video inputs. One particular “Home Theater System” sold by Pioneer is a television with the conventional two speakers built into the cabinet. A surround-sound box containing two additional speakers and a control panel for the sound is a separate component external to the cabinet that is typically placed on the top of the cabinet. The speakers in the surround-sound box are connected to the S-video inputs. Included in this Home Theater System is an additional bass box placed in the room external to the television cabinet. One disadvantage of this Home Theater System is that two additional components must be connected to the television via connecting cables and may also require additional power cables.

Therefore, what is needed is a television capable of receiving television signals from broadcast RF signals, cable systems, and satellite systems in an integrated fashion so that the television requires no external tuner boxes. What is further needed is such a television that requires one set of controls, mounted within the chassis of the television, for all modes of television reception. What is still yet further needed is such a television that is controlled by a remote control device. What is additionally needed is such a television that has purchase-payment capability integrated into the television for purchasing items associated with a television program. What is additionally needed is such a television that provides surround sound capability, multimedia capability, including teleconferencing, DVD, and picture-in-picture capabilities, all integrated into the television chassis, without requiring additional connecting cables and power cables.

### SUMMARY OF THE INVENTION

For the reasons cited above, it is an object of the present invention to provide a television capable of receiving broadcast RF signals, cable television signals, and satellite signals. It is a further object to provide such a television that is capable of receiving signals from additional sources, including the Internet. It is a yet further object to provide such a set with surround-sound and multimedia capabilities, and purchase-payment capability that is enclosed within a single chassis and operated by a remote control device.

The objects of the invention are met by providing a television that contains within a single cabinet the television display means and all of the circuit modules for broadcast signals, cable signals, and satellite signals. Additionally, the present invention provides a television that is linked to or is manipulated by a single remote control device capable of activating all of the operations of signal-reception. Also, the present invention provides the viewer with means to effect the purchase of “pay-per-view” programming and other services and goods—including notably, games from specific vendors such as Sony, Sega, and Nintendo—directly through an purchase-payment capability that is integrated into the television.

The present invention also provides surround-sound capability, that is, a sound system that provides the person listening to the television with the perception that the sound is coming from the front of, the sides of, and from the behind the listener, even though no speaker is placed behind the listener. Multimedia capabilities, including, but not limited to, DVD, teleconferencing in conjunction with a camera, picture-in-picture (PIP) capability, broadband reception, and a computer are also provided as components that are fully integrated into the cabinet of the television and are controlled by a wireless control system. The computer is, for example, a personal computer system, complete with hard drive and CD-ROM drive, that communicates with peripheral computer devices, such as keyboard and mouse, by wireless means. The wireless control system can be, but is not limited to, infra-red (IR) systems well known in the art.

The present invention includes a cable/satellite/Internet-ready television having a single set of controls that the viewer uses to select from among the following: (1) a mode of transmission, including RF broadcast, cable, phone line, satellite, or external video game; and, (2) a desired channel and/or Web address (Uniform Resource Location [URL]). The television is enclosed in a main television chassis that has inputs for antenna, cable, video, including those for video games, such as, for example, Sony's PlayStation 2, Nintendo 64, and Sega Genesis, audio, and satellite receiver. In certain embodiments, the television of the present invention is equipped with inputs for Ethernet and/or other broadband signal connections. In other embodiments, the television of the present invention is equipped with a modem. The satellite receiver has broadband capabilities.

It will be understood that within the scope of the present invention, the cable signal transmission mode is capable of conveying both television signals and Internet signals. The term “television” as used herein includes reference to High Definition television (HDTV). Furthermore, as used herein, the term “cable” includes reference to coaxial cable, Composite-video cable, S-video cable, Component-video cable, and optical cable. It will be further understood that, within the scope of the present invention, the Internet may be accessed by different means including, by way of non-limiting example, Ethernet, phone line, cable, and satellite receiver. Finally, the scope of the present invention anticipates that new cable formats for television and/or video signals will be developed. Therefore, the present invention will have increased utility as these new cable formats are developed.

The main television chassis is connected to a television or satellite a/c power cord and feeds the incoming television signal to the television tuner/demodulator. It is possible, of course, that a cable/satellite/Internet-ready television is equipped with a main television chassis and a main satellite chassis. In this case, the television signal comes in to the main television chassis, which is connected to the satellite, cable, or antenna system. The main television chassis then feeds the television signal to the main satellite chassis, which then feeds the signal to the television tuner/demodulator. The detailed description of the present invention set forth below is based on a television that is equipped with both a main television chassis and a main satellite chassis, although it is understood that it is well within the scope of the present invention to have a television that is equipped with only one main television chassis that receives incoming RF, cable, satellite, S-video, or wideband data signals and feeds the television signal to the television tuner/demodulator.

The television of the present invention is equipped with a satellite system access means that is mounted within the television cabinet. In some embodiments this access means is an access card assembly. Such an access card assembly includes a receiver slot for the satellite access card and is connected to the satellite receiver on the main satellite chassis. The satellite system access means and cable/satellite control panel are contained within the television cabinet, as are the main television chassis and the main satellite chassis with the digital satellite receiver input. The scope of the present invention includes all satellite system access means well-known in the art. In addition to the above stated card assembly, such satellite system access means include, but are not limited to, switches, buttons, timers, etc.

The present invention further includes purchase-payment capability by providing a credit/debit card reading device with which a viewer may conduct transactions including, for example, purchasing pay-per-view programming, purchasing video games to down load over a transmission source from vendors, purchasing goods over home-shopping channels (e.g., the Home Shopping Network, QVC, etc.), and purchasing goods over Web-TV. The credit card reader is, typically, of the type that reads the account information from the magnetic strip on the back of the credit/debit card; however, optical reading devices that read alphanumeric or holographic information stored on the credit/debit card are within the scope of the present invention.

In one embodiment, the credit/debit card reader is incorporated within the television chassis; in another, it is within the remote control device. Depending on the embodiment, the information “read” by the card reader may be transmitted to both the card-account institution and the vendor (of services/products being bought) over the same mode of transmission as the television signals or over a different mode of transmission. To illustrate the latter embodiment, a viewer intending to purchase a pay-per-view program would “swipe” his or her credit/debit card through a card reader incorporated into a remote control device that has cellular phone capability, while the television controlled by the remote control is receiving television signals over an optical cable network. In this case the credit/debit card information would be relayed over a cellular phone network, while the pay-per-view program would be received over another network, i.e., optical cable.

A cable/satellite/Internet control panel which contains transmission-mode/channel-selection controls is mounted on the front of the television and also connected to the satellite receiver input on the main satellite chassis. The receiver may be digital or analog or a digital/analog hybrid. The cable/satellite/Internet control panel can be activated by the user via a single remote control device or via manual controls (e.g., push-buttons, heat and/or electrical conductivity sensitive LCD screen, etc.). The user selects the desired RF/cable/satellite transmission mode by use of the remote control device, and then uses the remote control to select the desired mode and channel. It is, of course, possible to manually select the desired mode and channel by pressing an appropriate button on the cable/satellite/Internet control panel.

In those embodiments that have a remote control device, a cellular phone can be built into such a remote control. The term “cellular phone” refers to any wireless system having both a transmitter and a receiver, or just a transmitter by itself.

The television of the present invention includes a video display means. Three well-known video display means used with the present invention are cathode-ray picture tubes (CRTs), liquid crystal displays (LCDs), as well as wide screen projectors. With flat-screen televisions, such as those using LCDs, the question of where to place the various tuner boxes arises, as there is no cabinet on which to set them. Thus, one advantage of the television of the present invention is ease of use. The user of the present invention need only select a desired mode of signal transmission and a channel/URL, using only a single control panel that is integrated within the cabinet of the television and/or remote control device (or that is provided as a separate single control box in the case of a flat-screen television.) The scope of the present invention anticipates that new video display means will be developed. Therefore, the present invention will have increased utility as new video display means are developed.

The cable/satellite/Internet-ready television of the present invention further includes built-in surround-sound capability. Incorporated into the chassis are a power amplifier, a bass box, and multiple speakers that broadcast sound from various sides of the television chassis. The speakers are connected to the S-video inputs on the television chassis. Thus, the television comes set up for surround-sound, without the need to hook up additional speakers and amplifiers. A full sound control panel is integrated into the front panel of the cabinet which allows the operator to control the balance, volume or level, the bass, tremble, and effects. The surround-sound effect is achieved by a slight phase shift between the speaker outputs that creates the illusion of sound coming from several different directions, including from behind the listener. This surround-sound capability is particularly effective if the television is arranged in a corner of a room so that the sound broadcast from the rear side speakers of the television hits the walls nearby and is projected at an angle into the listening area.

In an alternative embodiment, multiple “satellite” speakers for the surround sound can be placed in the television viewing room external to the television chassis and communicate with the television by means of a conventional wireless control system, such as an IR system, that is integrated into the television chassis. In this alternative embodiment, the speakers are placed in different locations about the room, but communicate with and are controlled by means of IR signals. Thus, the speakers are placed about the room and are controlled by the television, but have no cables connecting them to the television.

The cable/satellite/Internet-ready television of the present invention also includes multimedia capabilities integrated within the television. Additionally, the cable/satellite/Internet-ready television of the present invention provides for picture-in-picture (PIP) display, as well as for teleconferencing by means of a camera integrated within the set. Although the camera is a digital one in Preferred Embodiments, an analog camera is also within the scope of the present invention. A personal computer including at least a hard drive and CD-ROM drive is also integrated into the cable/satellite/Internet ready television of the present invention. The external, peripheral components of the computer, such as mouse and keyboard, are in communication with the computer via a wireless communication system; e.g., an infrared (“IR”) laser system. Furthermore, the cable/satellite/Internet-ready television of the present invention includes a DVD player that is integrated within the television chassis and includes those types that are “writeable”.

The cable/satellite/Internet-ready television of the present invention, having only a single control box and single power cord, is very simple to hook up and eliminates the aesthetic drawbacks of the prior art by doing away with the numerous unsightly tuner boxes stacked on top of the television cabinet or on the floor, along with the tangle of power and connecting cords.

### DESCRIPTION OF THE ILLUSTRATIONS

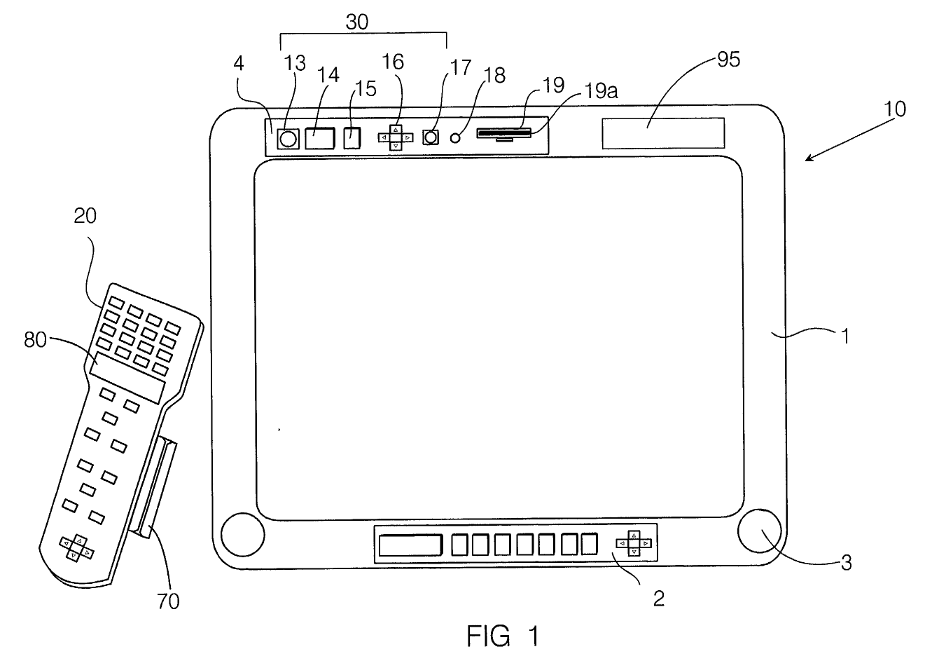

FIG. 1 is a front view of a television with remote control according to the present invention.

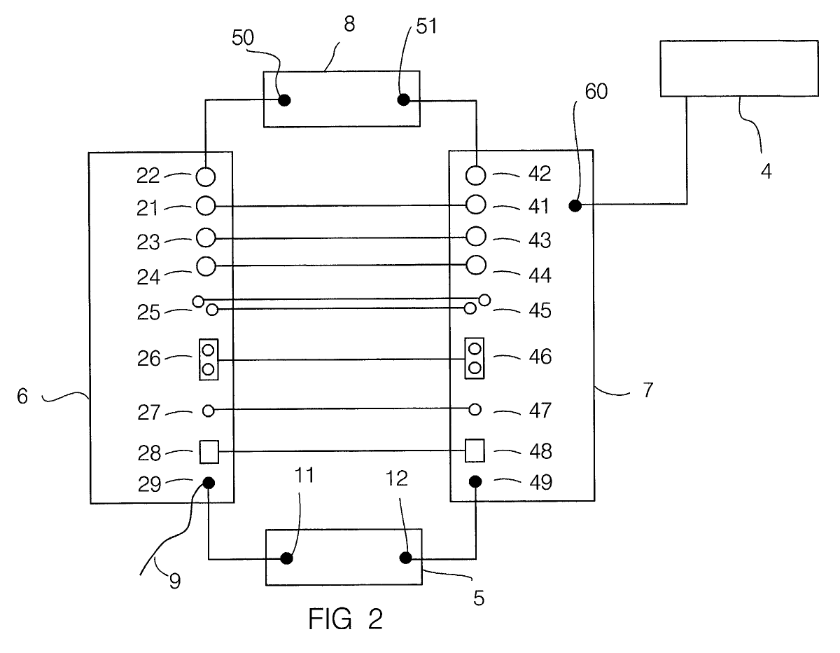

FIG. 2 is a block diagram of the main television chassis and the main satellite chassis of the present invention, showing the inputs on the main television chassis and the connections to the main satellite chassis.

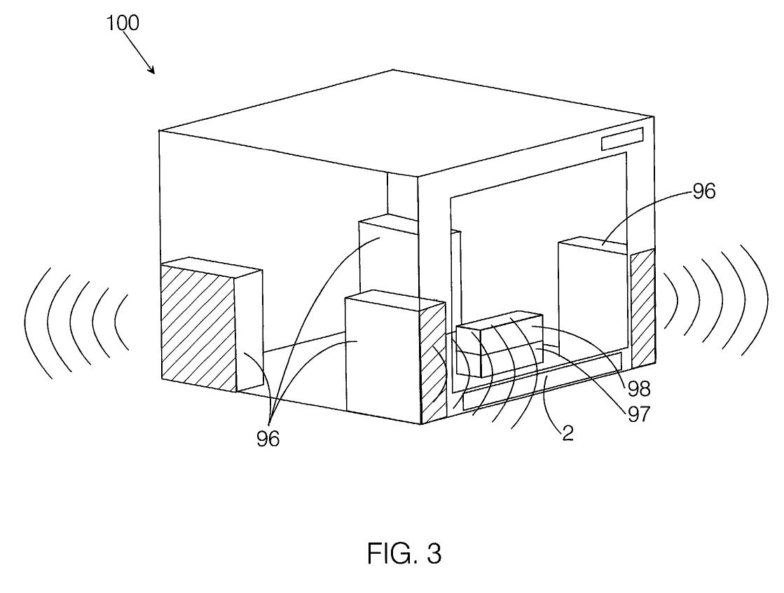

FIG. 3 illustrates the multiple speakers, the bass box, and the power amplifier integrated into the television according to the invention to provide surround-sound capability.

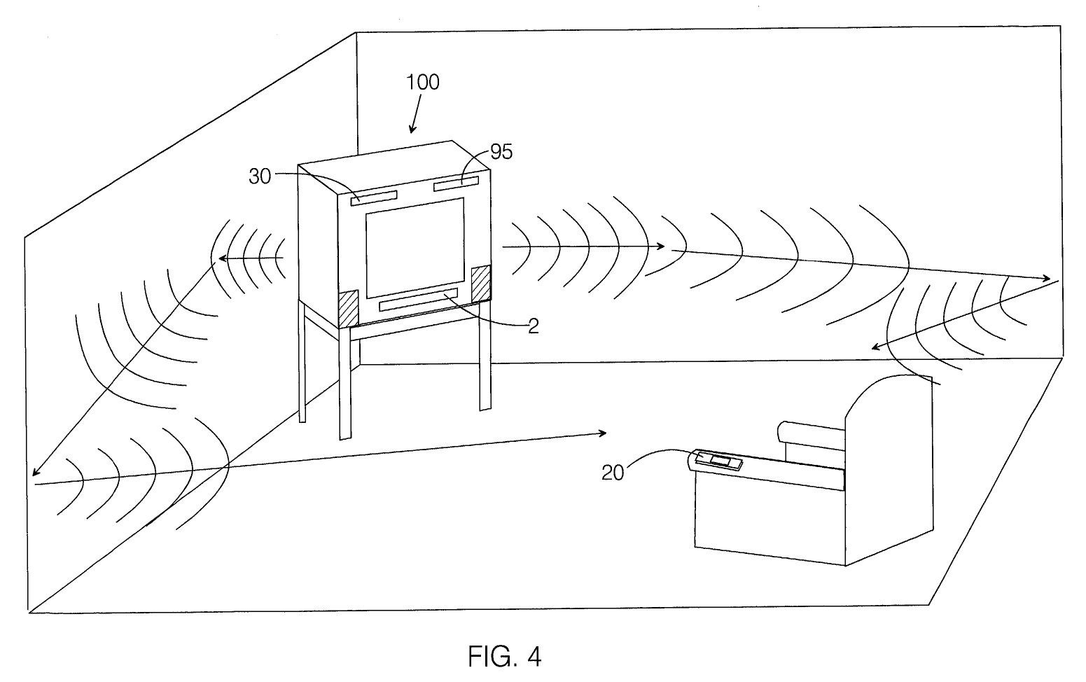

FIG. 4 illustrates the television with surround-sound capability, with

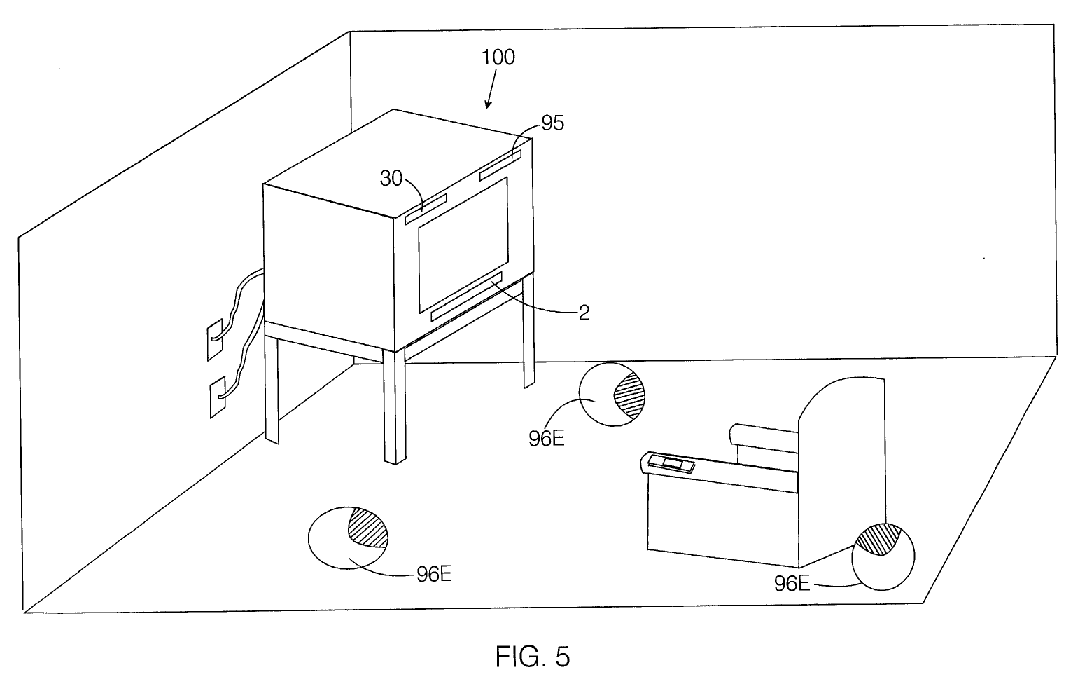

FIG. 5 illustrates the television according to the invention with surround-sound capability, with satellite speakers placed externally to the television.

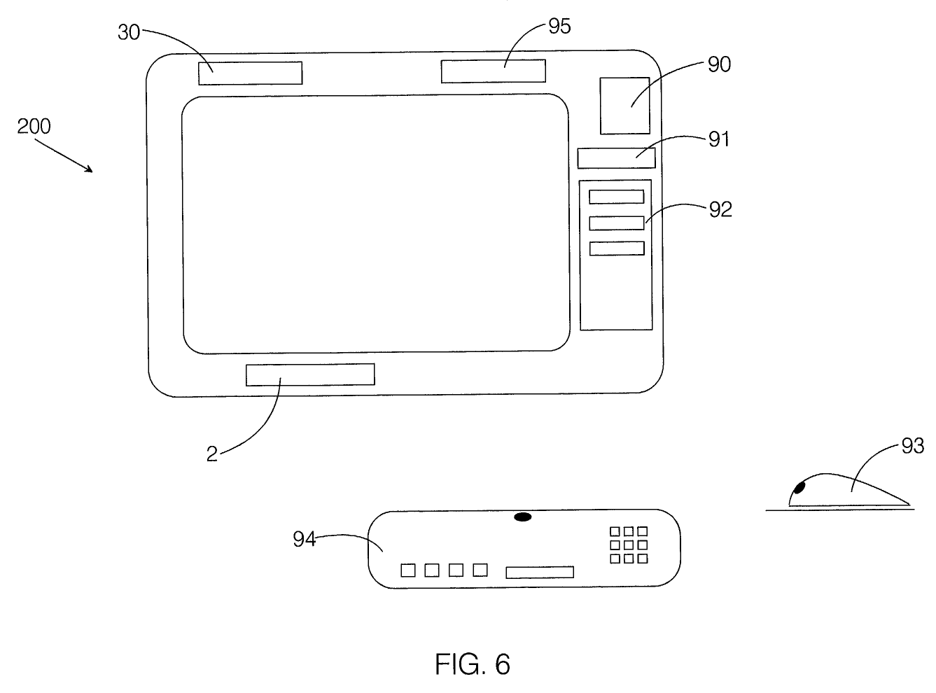

FIG. 6 shows a television according to the invention, with multimedia devices and a computer.

### DETAILED DESCRIPTION OF EMBODIMENTS OF THE INVENTION

The Preferred Embodiment of the present invention includes a cable/satellite/Internet-ready television 10, a front view of which is shown in FIG. 1. A schematic diagram of the connections for receiving the RF, cable, and satellite signals is shown in FIG. 2.

Referring to FIG. 1, it can be seen that the television 10 is equipped with a standard television control panel 2 and speakers 3. In addition, the television 10 has a transmission-mode/channel/URL-control panel 4 that is integrated into a cabinet 1 of the television 10. The transmission-mode/channel/URL control panel 4 includes a satellite-on/off-message-indicator 13, a series of manual control buttons 30, an infrared receiver for remote control 18, and a satellite access card slot 19. The manual control buttons 30 include a select-and-display button 14, a television/satellite/Internet selection button 15, four directional buttons 16, and a menu button 17. These are provided for manual selection of the transmission mode and channel/URL.

A main television chassis 6, a main satellite chassis 7, a standard television tuner/demodulator 8, and a power supply 5 are built into the television 10. As can be seen in the schematic diagram shown in FIG. 2, the main television chassis 6 of the Preferred Embodiment has a series of inputs that includes a first antenna input 21, a first superior-video (S-video) input 23, a first video input 24, a first pair of audio inputs 25, a first broadband-data-input 26, a first satellite input 27, a first modem connector 28, and a first alternating current (a/c) power input 29. An a/c power source 9 is connected to the first a/c power input 29, and that in turn is connected via an internal power supply 5 to a second a/c power input 49 on the main satellite chassis 7. The main television chassis 6 also has a first television output 22 that is connected to the tuner/demodulator 8, shown in FIG. 2 at 50.

Each of the inputs and the output on the television main chassis 6 is connected to a corresponding second input or output on the main satellite chassis 7. Thus, the first antenna input 21 is connected to a second antenna input 41, the first S-video input to a second S-video input 43, the first video input 24 to a second video input 44, the first pair of audio inputs 25 to a second pair of audio inputs 45, the first broadband data-input 26 to a second broadband-data-input 46, the first satellite input 27 to a second satellite input 47, and the first modem connector 28 to a second modem connector 48. The first television output 22 is also connected to a second television output 42, that in turn is also connected to the tuner/demodulator 8, shown in FIG. 2, at 51. The transmission-mode/channel-selection panel 4, shown in FIG. 1, is connected to a digital satellite receiver 60 on the main satellite chassis 7. The connections from the transmission-mode/channel-selection panel 4 are well-known in the field and are not described herein in any detail as those connections are not included within the scope of the present invention.

FIG. 3 shows a further development of the Preferred Embodiment, a television 100 equipped for surround-sound. Multiple speakers 96 are provided within the chassis of the television 100 and are connected to the S-video sound inputs on the chassis. These speakers 96 are placed to the left front, right front, left rear and right rear of the chassis. A bass box 97 is arranged on the bottom of the chassis and broadcasts sound downward from the chassis. The surround-sound equipped television 100 also includes a power amplifier 98.

FIG. 4 shows a the television 100 placed in a corner of the room, so as to enhance the surround-sound effect. Having the sound hit the walls of the room at an angle to deflect the sound into the room so that sound waves from particular speakers are perceived as coming from behind the listener, as shown in FIG. 4, enhances the surround-sound effect, but it is not necessary to place the television in a corner to obtain this effect. Connecting the four speakers to the S-video sound inputs will provide the necessary phase shift to obtain a surround-sound effect.

FIG. 5 shows an alternative embodiment of the television 100. In this embodiment, the television is equipped with an IR system 95, and external speakers 96E are placed external to the television 100 and are controlled by the television 100 by means of the IR system 95.

FIG. 6 shows a television 200 that is similar to the television 10, but also has multimedia devices built into the chassis. The multimedia devices include a write-able DVD player 90, a digital camera 91 for teleconferencing, and a personal computer 92. The computer 92 is complete with hard drive, CD-ROM drive and enables Web pages to be shown in a PIP format on the television screen. In so far as components of the computer are external to the television chassis, such as a mouse 93 and a keyboard 94, they are in communication with the computer 92 by means of the IR system 95.

For the sake of simplicity, the surround-sound equipped television and the multimedia capable television were shown as separate devices. It should be understood that the scope of the invention includes a television that incorporates the surround-sound, multimedia, IR, credit/debit card reader into one and the same chassis for the satellite/cable/Internet-ready television according to the invention. 43. The user will typically control the television by means of a remote control 20, shown in FIG. 1. With the use of this remote control device 20, the user will be able to select the desired mode of television signal transmission (rf, cable, satellite) and the channel, video or S-video, or broadband-data-input, as well as execute other well-known functions, such as turning the television 10 on or off, controlling the volume or the video, and so forth. The remote control device 20 also includes a credit/debit card reader 70, which in the Preferred Embodiment is of the ‘swipe’ type attached to the remote control device 20. Moreover, the remote control device 20 includes a cellular phone section 80 that enables the credit/debit card reader 70 to transmit and receive data. Cellular telephone technology, as well as credit/debit card reader technology, is well-known in the field and is not described herein with any detail.

While a Preferred Embodiment is disclosed, this is not intended to be limiting. Rather, the general principles set forth herein are considered to be merely illustrative of the scope of the present invention and it is to be further understood that numerous changes may be made without straying from the scope of the present invention.

What is claimed is:

1. A cable/satellite/Internet-ready television comprising:
a television chassis,
a television screen,
a cabinet,
a television control panel that includes a transmission-mode/channel selection panel, and a television tuner/demodulator having a first tuner/demodulator input and a second tuner/demodulator input, wherein said television control panel and said television tuner/demodulator are built into said cabinet, and
a purchase-payment means for purchasing goods and services from television programs broadcast through said television.

2. The cable/satellite/Internet-ready television of claim 1, wherein said purchase-payment means is a credit/debit card reader that is incorporated within said cabinet.

3. The cable/satellite/Internet-ready television of claim 1, further comprising a wireless control system integrated into said cabinet.

4. The cable/satellite/Internet-ready television of claim 3 further comprising a remote control device capable of communicating with said television by means of said wireless control system.

5. The cable/satellite/Internet-ready television of claim 4, wherein said purchase-payment means is a credit/debit card reader that is incorporated within said remote control device.

6. The cable/satellite/Internet-ready television of claim 4, wherein said remote control device includes a cellular phone.

7. The cable/satellite/Internet-ready television of claim 1 further comprising a DVD player integrated within said cabinet.

8. The cable/satellite/Internet-ready television of claim 1 further comprising a camera integrated within said cabinet.

9. The cable/satellite/Internet-ready television of claim 8, wherein said camera is a digital camera.

10. The cable/satellite/Internet-ready television of claim 3, wherein said wireless control system is an infra-red system and an infra-red control device is arranged on said cabinet for transmitting signals between said television and said remote control device.

11. The cable/satellite/Internet-ready television of claim 3, wherein said wireless control system is a radio control system and a radio receiver/transmitter device is arranged on said cabinet for transmitting signals between said television and said remote control device.

12. The cable/satellite/Internet-ready television of claim 3 further comprising a computer that is integrated within said cabinet, wherein computer peripheral devices are external to said cabinet and are communicable with said computer via said wireless control system.

13. The cable/satellite/Internet-ready television of claim 12, wherein said peripheral devices include one or more devices from a group consisting of a keyboard, a mouse, a joystick, a headset, and speakers.

14. The cable/satellite/Internet-ready television of claim 1 further comprising:
a sound control panel,
a plurality of sound speakers,
a power amplifier, and
a bass box,
wherein said sound speakers, said power amplifier and said bass box are integrated within said cabinet and said sound control panel is arranged on said cabinet so as to be easily accessible by an operator of said television.

15. The cable/satellite/Internet-ready television of claim 14, wherein said plurality of sound speakers includes at least four speakers.

16. The cable/satellite/Internet-ready television of claim 3, wherein said television comprises:
a plurality of sound speakers,
a power amplifier, and
a bass box,
wherein one or more of said sound speakers, said power amplifier, and said bass box are arranged external to said cabinet and are in communication with and controlled by said wireless communication system.

17. A television comprising a cabinet and a purchase-payment means that enables purchase of goods and services from television programs broadcast through said television.

18. A television comprising a cabinet and a DVD player integrated within said cabinet.

19. A television comprising a cabinet and a camera integrated within said cabinet.

20. The television of claim 19, wherein said camera is a digital camera.

21. A television comprising:
a cabinet,
a wireless control system integrated into said cabinet, and
a computer that is integrated within said cabinet and wherein computer peripheral devices are external to said cabinet and are capable of communicating with said computer via said wireless control system.

22. The television of claim 21, wherein said computer is a personal computer having a hard drive and a CD-ROM drive.

23. The television of claim 21, wherein said wireless control system is an infra-red system and an infra-red control device is arranged on said cabinet for transmitting signals between said television and said remote control device.

24. The television of claim 21, wherein said wireless control system is a radio control system and a radio receiver/transmitter device is arranged on said cabinet for transmitting signals between said television and said remote control device.

25. The television of claim 21, wherein said computer peripheral devices include one or more devices from a group consisting of a keyboard, a mouse, a joystick, a headset, and speakers.

26. A television having a cabinet, said television comprising:
a sound control panel,
a plurality of sound speakers,
a power amplifier, and
a bass box,
wherein said sound speakers, said power amplifier and said bass box are integrated within said cabinet and said sound control panel is arranged on said cabinet so as to be easily accessible by an operator of said television.

27. The television of claim 29, wherein said plurality of sound speakers includes at least four speakers.
